(19) United States
(12) Patent Application Publication
(10) Pub. No.: US 2021/0192725 A1
(43) Pub. Date: Jun. 24, 2021

(54) METHOD, APPARATUS AND ELECTRONIC DEVICE FOR DETERMINING SKIN SMOOTHNESS

(71) Applicant: Beijing Baidu Netcom Science Technology Co., Ltd., Beijing (CN)

(72) Inventors: Zhizhi GUO, Beijing (CN); Yipeng SUN, Beijing (CN); Jingtuo LIU, Beijing (CN); Junyu HAN, Beijing (CN); Duo YANG, Beijing (CN); Yue DANG, Beijing (CN); Huichao WANG, Beijing (CN)

(21) Appl. No.: 17/021,114

(22) Filed: Sep. 15, 2020

(30) Foreign Application Priority Data
Mar. 31, 2020 (CN) 202010242706.4

(51) Int. Cl. G06T 7/00

(52) U.S. Cl. CPC G06T 7/0012; G06T 2207/30201; G06T 2207/30088; G06T 2207/20081

(57) ABSTRACT

The present disclosure discloses a method, apparatus and electronic device for determining skin smoothness, which relates to the field of computer vision technologies. The specific implementation solution is as follows: when the skin smoothness is calculated, an image to be detected including a face area is obtained first, and then the image to be detected and a smoothness analysis mask image corresponding to the image to be detected are inputted into a deep learning model to obtain a plurality of feature vectors for indicating the skin smoothness of the face. Because the smoothness analysis mask image does not include preset factors including at least one of five sense organs, reflection and hair, the influence of the preset factors on the skin smoothness is avoided, so that the accuracy for the skin smoothness of the face is ensured to a certain extent.

### CROSS-REFERENCE TO RELATED APPLICATION

This application claims priority to Chinese Patent Application No. 202010242706.4, filed on Mar. 31, 2020, which is incorporated herein by reference in its entirety.

### TECHNICAL FIELD

The present disclosure relates to the field of image processing technologies, and in particular to the field of computer vision technologies.

### BACKGROUND

In the prior art, when skin smoothness of a face is calculated, in general, characteristics, such as stains, wrinkles, pores and the like, of facial skin are detected first, and then the severity of the stains, wrinkles and pores of the facial skin is weighted to obtain the skin smoothness of the face. Efficiency for calculating the skin smoothness of the face is low due to a large amount of data when the characteristics such as spots, wrinkles, pores and the like of the facial skin are detected.

Therefore, an urgent problem to be solved for those skilled in the art is how to improve the efficiency for calculating the skin smoothness of the face while ensuring the accuracy, when the skin smoothness of the face is calculated.

### SUMMARY

Embodiments of the present disclosure provide a method, an apparatus and an electronic device for determining skin smoothness, so as to improve the efficiency for calculating the skin smoothness of a face while ensuring the accuracy.

In a first aspect, an embodiment of the present disclosure provides a method for determining skin smoothness, comprising:

obtaining an image to be detected, where the image to be detected includes a face area;

inputting the image to be detected and a smoothness analysis mask image corresponding to the image to be detected into a deep learning model to obtain a plurality of feature vectors for indicating skin smoothness of a face; where the smoothness analysis mask image does not includes preset factors and the preset factors include at least one of five sense organs, reflection and hair; and

determining, according to the plurality of feature vectors, the skin smoothness of the face in the image to be detected.

In a second aspect, an embodiment of the present disclosure provides an apparatus for determining skin smoothness, comprising:

an obtaining module, configured to obtain an image to be detected, where the image to be detected includes a face area.

a processing module, configured to input the image to be detected and a smoothness analysis mask image corresponding to the image to be detected into a deep learning model to obtain a plurality of feature vectors for indicating skin smoothness of a face; and determine, according to the plurality of feature vectors, the skin smoothness of the face in the image to be detected; where the smoothness analysis mask image does not includes preset factors and the preset factors include at least one of five sense organs, reflection and hair.

In a third aspect, an embodiment of the present disclosure provides an electronic device, comprising:

at least one processor; and

a memory, connected with the at least one processor in communication;

wherein the memory stores instructions executable by the at least one processor, and the instructions are executed by the at least one processor to cause the at least one processor to perform the method for determining skin smoothness according to the above first aspect.

In a fourth aspect, an embodiment of the present disclosure further provides a non-transitory computer-readable storage medium storing computer instructions, where the computer instructions are configured to cause a computer to perform the method for determining skin smoothness according to the above first aspect.

According to the technical solutions of the present disclosure, when the skin smoothness is calculated, there is no need to detect the characteristics such as stains, wrinkles, pores and the like, of the facial skin and weight the severity of the stains, wrinkles, pores and the like, of the facial skin to obtain the skin smoothness of the face, but employs such a solution that: after an image to be detected including a face area is obtained, the image to be detected and a smoothness analysis mask image corresponding to the image to be detected are inputted into a deep learning model to obtain a plurality of feature vectors for indicating the skin smoothness of the face. Because the smoothness analysis mask image does not include preset factors including at least one of five sense organs, reflection and hair, the influence of the preset factors on the skin smoothness is avoided, so that the accuracy for the skin smoothness of the face is ensured to a certain extent. Furthermore, the skin smoothness of the face in the image to be detected is obtained according to the plurality of feature vectors, thereby improving the efficiency for calculating the skin smoothness of the face while ensuring the accuracy.

It should be understood that the content described in this portion is not intended to identify key or important features of embodiments of the present disclosure, nor to limit the scope of the present disclosure. Other features of the present disclosure will become easily understood by the following description.

### BRIEF DESCRIPTION OF DRAWINGS

The drawings are used to understand the solution of the present disclosure better, and do not constitute limitation on the present disclosure. In the drawings:

FIG. 1 is a scene view to realize a method for determining skin smoothness of an embodiment of the present disclosure;

FIG. 2 is a schematic block diagram of a method for determining skin smoothness provided according to an embodiment of the present disclosure;

FIG. 3 is a schematic flow chart of a method for determining skin smoothness provided according to a first embodiment of the present disclosure;

FIG. 4 is a schematic view of a smoothness analysis mask image according to the first embodiment of the present disclosure;

FIG. 5 is a schematic flow chart of obtaining a smoothness analysis mask image corresponding to an image to be detected according to a second embodiment of the present disclosure;

FIG. 6 is a schematic structural diagram of an apparatus for determining skin smoothness according to a third embodiment of the present disclosure; and

FIG. 7 is a block diagram of an electronic device for performing the method for determining skin smoothness according to an embodiment of the present disclosure.

### DESCRIPTION OF EMBODIMENTS

The following describes exemplary embodiments of the present disclosure in combination with the drawings, where various details of embodiments of the present disclosure are included so as to facilitate understanding, and they should be considered as exemplary merely. Therefore, those skilled in the art should understand that various changes and modifications can be made to the embodiments described herein without departing from the scope and spirit of the present disclosure. Similarly, for clarity and simplicity, the description for the well-known functions and structures is omitted in the following description.

In embodiments of the present disclosure, the phrase “at least one” refers to one or more, and “a plurality of” refers to two or more. The expression “and/or” describes the association relationship among associated objects, which indicates existence of three types of relationships. For example, the expression “and/or” may indicate three cases including existence of A alone, existence of both A and B at the same time, and existence of B alone, where A and B can be singular or plural. In text description of the present disclosure, the character “I” generally indicates that the relationship between the front and rear associated objects is the relationship of “or”.

A method for determining skin smoothness according to embodiments of the present disclosure can be applied to the scene of detecting skin smoothness. For example, please refer to FIG. 1, which is a scene view to realize the method for determining skin smoothness of an embodiment of the present disclosure. When calculating skin smoothness of a face in an image, an electronic device detects characteristics, such as stains, wrinkles, pores and the like, of the facial skin first, and then weights the severity of stains, wrinkles and pores of the facial skin to obtain the skin smoothness of the face. Efficiency for calculating the skin smoothness of the face is low due to a large amount of data when the characteristics, such as spots, wrinkles, pores and the like, of the facial skin are detected.

In order to improve the efficiency for calculating the skin smoothness of the face, it has been tried that a color spatial pixel value of an image including a face area is used directly to calculate a mean value of absolute values of deviations, and the mean value of absolute values of the deviations is taken as the eigenvalue of the skin smoothness of the face, so as to identify the skin smoothness of the face. However, this method performs color processing for the image in pixel level only. This method does not exclude the interference of five sense organs, hair, reflection and other factors of the skin, and furthermore color features of the image are easily affected by external light. Therefore, this method is only suitable for the ideal laboratory environment, and the recognition accuracy and robustness in the natural environment are limited.

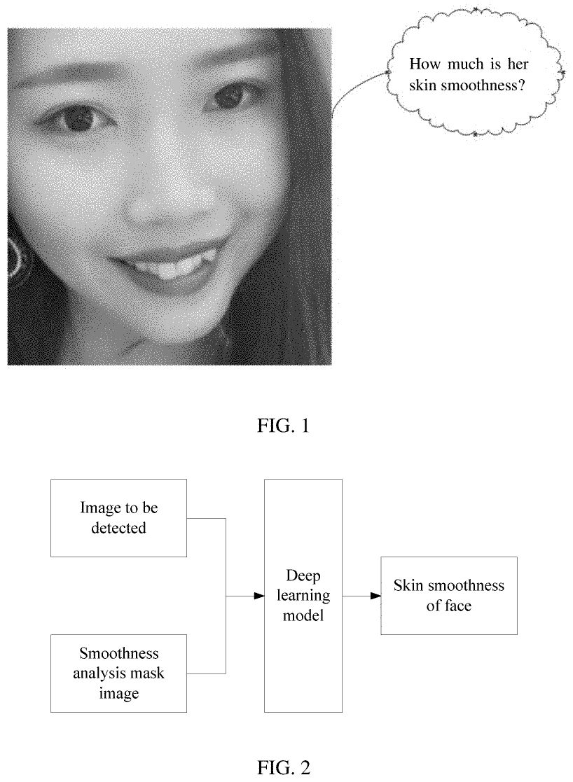

Based on this, after long-term creative work, a method for determining the skin smoothness is provided by an embodiment of the present disclosure. After an image to be detected including a face area is obtained, the image to be detected and a smoothness analysis mask image corresponding to the image to be detected are inputted into a deep learning model to obtain a plurality of feature vectors for indicating the skin smoothness of the face; wherein the smoothness analysis mask image does not include preset factors, and the preset factors include at least one of five sense organs, reflection or hair; and the skin smoothness of the face in the image to be detected is determined according to the plurality of feature vectors. For example, please refer to FIG. 2, which is a schematic block diagram of a method for determining skin smoothness according to an embodiment of the present disclosure.

It can be seen that when the skin smoothness is calculated, the method for determining skin smoothness according to the embodiment of the present disclosure no longer needs to detect the characteristics, such as stains, wrinkles, pores and the like, of the facial skin and weight the severity of the stains, wrinkles and pores of the facial skin to obtain the skin smoothness of the face, but employs such a solution that: after an image to be detected including a face area is obtained, the image to be detected and a smoothness analysis mask image corresponding to the image to be detected are inputted into a deep learning model to obtain a plurality of feature vectors for indicating the skin smoothness of the face. Because the smoothness analysis mask image does not include preset factors, and the preset factors include at least one of five sense organs, reflection and hair, the influence of the preset factors on the skin smoothness is avoided, so that the accuracy for skin smoothness of the face is ensured to a certain extent. Furthermore, the skin smoothness of the face in the image to be detected is obtained according to the plurality of feature vectors, thereby improving the efficiency for calculating the skin smoothness of the face while ensuring the accuracy.

In the following, the method for determining skin smoothness according to the present disclosure will be described in detail through specific embodiments. It can be understood that the following specific embodiments can be combined with one another, and the same or similar concepts or processes may not be described repeatedly in some embodiments.

### First Embodiment

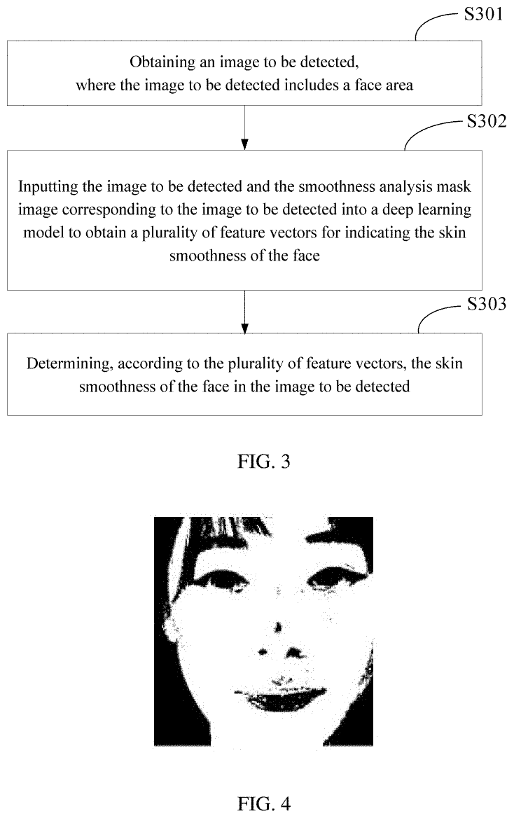

FIG. 3 is a flow chart of the method for determining skin smoothness provided according to the first embodiment of the present disclosure. The method for determining skin smoothness may be performed by software and/or hardware apparatuses. For example, the hardware apparatus may be an apparatus for determining skin smoothness, which may be arranged in an electronic device. For example, as shown in FIG. 3, the method for determining skin smoothness can include:

S301: Obtaining an image to be detected.

The image to be detected includes a face area, and pixels in the image to be detected satisfy pixel requirements. In the embodiment of the present disclosure, the purpose for unifying the pixels in the image to be detected is to enable the pixels in the image to be detected to be at the same pixel level when the skin smoothness of the face in the image to be detected is calculated by the image to be detected, in such a way to prevent the calculated skin smoothness of the face from errors due to different pixels.

For example, when the image to be detected is obtained, the image to be detected sent by other devices can be directly received; alternatively, an initial image to be detected that is inputted by a user can be received. As shown in FIG. 1, since the pixels of the initial images to be detected that are inputted by respective users are not unified, in order to unify the pixels of the images to be detected, the pixels of the initial images to be detected can be preprocessed to obtain processed images to be detected. For example, the preprocessing for the pixels of the initial image to be detected can be pixel normalization processing, or it can be color channel conversion processing and the like, which can be set according to actual requirements. Here, the embodiments of the present disclosure do not further limit the method for preprocessing the pixels of the initial image to be detected.

Different from the prior art, in the embodiment of the present disclosure, when the skin smoothness is calculated, there is no need to detect the characteristics, such as the stains, wrinkles and pores and the like, of the facial skin and weight the severity of the stains, wrinkles and pores of the facial skin to obtain the skin smoothness of the face, but employs such a solution that: after the image to be detected including the face area is obtained, the image to be detected and a smoothness analysis mask image corresponding to the image to be detected are inputted into a deep learning model to obtain a plurality of feature vectors for indicating the skin smoothness of the face, and the skin smoothness of the face in the image to be detected is then determined according to the plurality of feature vectors, that is, the following steps S302-S303 are performed:

S302: Inputting the image to be detected and the smoothness analysis mask image corresponding to the image to be detected into a deep learning model to obtain a plurality of feature vectors for indicating the skin smoothness of the face.

The smoothness analysis mask image does not include preset factors, where the preset factors include at least one of five sense organs, reflection, and hair. It can be understood that the preset factors may also include other factors that will affect the accuracy of skin smoothness. Here, the embodiments of the present disclosure only take the preset factors including at least one of five sense organs, reflection and hair as an example, but it does not mean that the embodiments of the present disclosure are limited to this. For example, the smoothness analysis mask image corresponding to the image to be detected can be shown in FIG. 4, which is the schematic view of the smoothness analysis mask image provided by the first embodiment of the present disclosure. It can be seen that the smoothness analysis mask image shown in FIG. 4 only includes black pixels and white pixels, wherein the black pixels are not used to calculate the skin smoothness of the face subsequently, but white pixels are used to calculate the skin smoothness of the face subsequently.

It should be noted that in the embodiment of the present disclosure, it is considered that the preset factors will affect the calculation of the skin smoothness of the face; therefore, these preset factors can be removed first, and subsequently, the smoothness analysis mask image after removing the preset factors is used to calculate the skin smoothness of the face, thereby avoiding the influence of the preset factors on the calculation of the skin smoothness of the face, and ensuring the accuracy of the skin smoothness of the face obtained through the calculation to a certain extent.

It is not difficult to understand that in the embodiment of the present disclosure, before inputting the image to be detected and the smoothness analysis mask image corresponding to the image to be detected into the deep learning model to obtain the plurality of feature vectors for indicating the skin smoothness of the face, the deep learning model needs to be determined first. The deep learning model is obtained by training an initial deep neural network model with multiple groups of sample data, where each group of the sample data include a sample image, a smoothness analysis mask image corresponding to the sample image and feature vectors for indicating the skin smoothness of the face in the sample image. The deep learning model is mainly used to predict a plurality of feature vectors for indicating the skin smoothness of the face, so as to calculate the skin smoothness of the face in the image to be detected according to the plurality of predicted feature vectors.

For example, in the case that the initial deep neural network model is trained with the multiple groups of sample data to obtain the deep learning model, the initial deep neural network model can include but is not limited to: ResNet-18, inception-v3, inception-v4 and other network models. After the initial deep neural network model is determined, the initial deep neural network model can be trained with multiple groups of sample data, that is, the feature vectors for indicating the skin smoothness of the face in the sample image are added into the initial deep neural network model, that is, the features for indicating the skin smoothness of the face in multiple scales are combined to obtain multi-scale features with the relative scale invariant. For this, UNet, FPN or other common feature combination method can be used, and is not limited thereto, so that the ease of use and scalability of the deep learning model and multi-scale features can be ensured.

After the smoothness analysis mask image corresponding to the image to be detected and the deep learning model obtained by training are obtained, the image to be detected and the smoothness analysis mask image corresponding to the image to be detected are inputted into the deep learning model to obtain the plurality of feature vectors for indicating the skin smoothness of the face. For example, the plurality of feature vectors can be denoted by a one-dimensional array. When a plurality of features for indicating the skin smoothness of the face are feature 1, feature 2, feature 3, feature 4 and feature 5, respectively, the feature vectors corresponding to these five features can be [0.8, 0.5, 0.3, 0.4, 0.9]. Among them, 0.8 denotes the value of the feature 1; 0.5 denotes the value of the feature 2; 0.3 denotes the value of the feature 3; 0.4 denotes the value of the feature 4; and 0.9 denotes the value of the feature 5. After the plurality of feature vectors [0.8, 0.5, 0.3, 0.4, 0.9] for indicating the skin smoothness of the face are obtained, the skin smoothness of the face in the image to be detected can be calculated according to the plurality of feature vectors [0.8, 0.5, 0.3, 0.4, 0.9], that is, the following step S303 is performed.

S303: Determining, according to the plurality of feature vectors, the skin smoothness of the face in the image to be detected.

Because the plurality of feature vectors are the vectors for indicating the skin smoothness of the face, after the plurality of feature vectors are obtained, the skin smoothness of the face in the image to be detected can be calculated and determined according to the plurality of feature vectors.

For example, when the skin smoothness of the face in the image to be detected is determined according to the plurality of feature vectors, the following at least three possible implementations may be included.

In a possible implementation, according to the values of the plurality of feature vectors, the first K feature vectors with larger values can be determined from the plurality of feature vectors; and then the skin smoothness of the face in the image to be detected can be calculated and determined according to the first K feature vectors and the weight corresponding to each feature vector of the first K feature vectors, where said K is an integer greater than 0, and the value of K can be set according to actual needs. Here, the embodiment of the present disclosure does not further limit the value of K. For example, in the embodiment of the present disclosure, the value of K can be 3.

For example, combined with the above description in S302, when the plurality of feature vectors are [0.8, 0.5, 0.3, 0.4 and 0.9], the first 3 feature vectors with larger values can be determined first, where the first 3 feature vectors with larger values are 0.8, 0.5 and 0.9 respectively, wherein said 0.8 corresponds to the feature 1, said 0.5 corresponds to the feature 2, and said 0.9 corresponds to the feature 5; and then the weight of the feature 1, the weight of the feature 2, and the weight of the feature 5 are determined respectively; subsequently the value of 0.8*the weight of the feature 1+0.5*the weight of the feature 2+0.9*the weight of the feature 5 is calculated, and the value obtained through the calculation is the skin smoothness of the face in the image to be detected.

In another possible implementation, according to the values of the plurality of feature vectors, R feature vectors with values greater than a preset threshold value can be determined from the plurality of feature vectors; and then the skin smoothness of the face in the image to be detected can be calculated and determined according to the R feature vectors and the weight corresponding to each feature vector of the R feature vectors. The preset threshold value can be set according to actual needs. Here, the embodiment of the present disclosure does not further limit the preset threshold value. For example, in the embodiment of the present disclosure, the preset threshold value can be 0.4.

For example, combined with the above description in S302, when the plurality of feature vectors are [0.8, 0.5, 0.3, 0.4 and 0.9], the feature vectors with values greater than 0.4 can be determined first from the plurality of feature vectors, where the feature vectors with values greater than 0.4 are 0.8, 0.5 and 0.9, wherein said 0.8 corresponds to the feature 1, said 0.5 corresponds to the feature 2, and said 0.9 corresponds to the feature 5; and then the weight of the feature 1, the weight of the feature 2, and the weight of the feature 5 are determined respectively; subsequently the value of 0.8*the weight of the feature 1+0.5*the weight of the feature 2+0.9*the weight of the feature 5 is calculated, and the value obtained through the calculation is the skin smoothness of the face in the image to be detected.

In yet another possible implementation, according to the values of the plurality of feature vectors, the feature vector with largest value can be determined from the plurality of feature vectors; and then the skin smoothness of the face in the image to be detected can be calculated and determined according to the feature vector with the largest value and the weight corresponding to the feature vector with the largest value.

For example, combined with the above description in S302, when the plurality of feature vectors are [0.8, 0.5, 0.3, 0.4 and 0.9], the feature vector with the largest value can be determined first from the plurality of feature vectors, where the feature vector with the largest value is 0.9, and said 0.9 corresponds to the feature 5; and then the weight of the feature 5 is determined; subsequently the value of 0.9*the weight of the feature 5 is calculated, and the value obtained through the calculation is the skin smoothness of the face in the image to be detected.

It can be seen that, in the embodiments of the present disclosure, when the skin smoothness is calculated, there is no need to detect the characteristics, such as stains, wrinkles, pores and the like, of the facial skin and weight the severity of the stains, wrinkles and pores of the facial skin to obtain the skin smoothness of the face, but employs such a solution that: after the image to be detected including a face area is obtained, the image to be detected and the smoothness analysis mask image corresponding to the image to be detected are inputted into the deep learning model to obtain a plurality of feature vectors for indicating the skin smoothness of the face. Because the smoothness analysis mask image does not include preset factors including at least one of five sense organs, reflection and hair, the influence of the preset factors on the skin smoothness is avoided, so that the accuracy for the skin smoothness of the face is ensured to a certain extent. Furthermore, the skin smoothness of the face in the image to be detected is obtained according to the plurality of feature vectors, thereby improving the efficiency for calculating the skin smoothness of the face while ensuring the accuracy.

In addition, it should be noted that in the embodiments of the present disclosure, when the skin smoothness of the face is calculated, the smoothness analysis mask image corresponding to the image to be detected is considered, so as to accurately detect the skin smoothness of the face in the natural environment, thereby greatly enriching the use scene of the system, and making the system more propagable and expandable.

It can be understood that in the embodiment shown in FIG. 3, before inputting the image to be detected and the smoothness analysis mask image corresponding to the image to be detected into the deep learning model to obtain the plurality of feature vectors for indicating the skin smoothness of the face as described in S302, it is necessary to first obtain the smoothness analysis mask image corresponding to the image to be detected. Only in this way, the image to be detected and the smoothness analysis mask image corresponding to the image to be detected can be inputted into the deep learning model to obtain the plurality of feature vectors for indicating the skin smoothness of the face, and then the skin smoothness of the face in the image to be detected can be obtained according to the plurality of feature vectors, thereby improving the efficiency for calculating the skin smoothness of the face while ensuring the accuracy. Hereafter, it will be described in detail in the second embodiment below how to obtain the smoothness analysis mask image corresponding to the image to be detected in the embodiments of the present disclosure.

### Second Embodiment

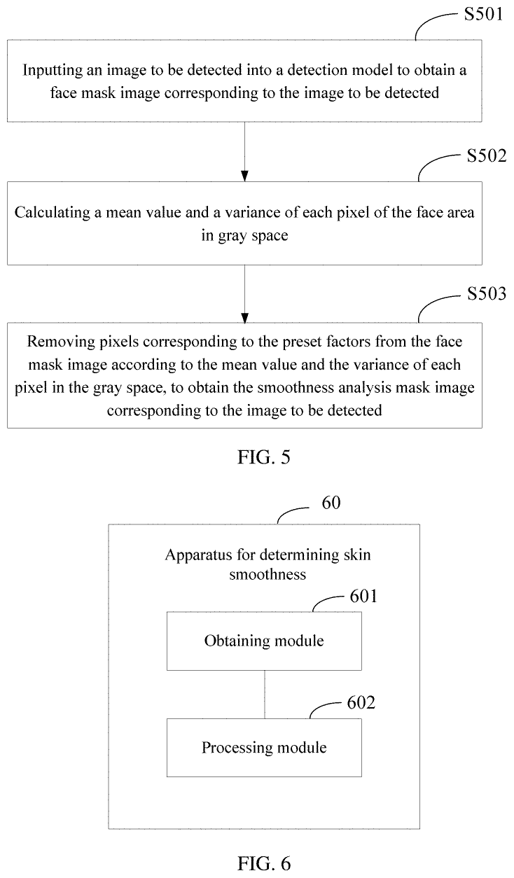

FIG. 5 is a schematic flow chart of obtaining a smoothness analysis mask image corresponding to an image to be detected according to a second embodiment of the present disclosure. For example, please refer to FIG. 5. The obtaining of the smoothness analysis mask image corresponding to the image to be detected may include:

S501: Inputting an image to be detected into a detection model to obtain a face mask image corresponding to the image to be detected.

For example, the detection model includes at least one of HSV color model, YCrCB color model, and RGB color model. It can be understood that the detection model can also be other color models. Here, the embodiments of the present disclosure only use the detection model being at least one of the HSV color model, YCrCB color model, and RGB color model as an example to explain, but it does not mean that the embodiments of the present disclosure are limited thereto.

For example, taking the detection model being the HSV color model and the RGB color model as an example, when the face mask image corresponding to the image to be detected is determined by the HSV color model and the RGB color model, it can be determined whether a pixel meets the following formula or not:
0.0≤H≤50.0 and 0.23≤S≤0.68 and R>95 and G>40 and B>20 and R>G and R>B and |R−G|>15 and A>15

If a pixel in the image to be detected meets the above formula, the color of the pixel will be changed to white, and the white pixel may be used to calculate the skin smoothness of the face subsequently; on the contrary, if a pixel in the image to be detected does not meet the above formula, the color of the pixel will be changed to black, and the black pixel may not be used to calculate the skin smoothness of the face subsequently. In such a way, the face mask image corresponding to the image to be detected is obtained.

The face mask image still includes the preset factors that may affect the calculation for the skin smoothness of the face, as a result, in order to avoid the influence of the preset factors on the calculation for the skin smoothness of the face, the preset factors can be removed from the face mask image when the skin smoothness of the face is calculated. For example, when the preset factors is removed from the face mask image, a mean value and a variance of each pixel of the face area in gray space can be calculated first, and then according to the mean value and the variance of the pixel in the gray space, the preset factors can be removed from the face mask image, so as to obtain the smoothness analysis mask image corresponding to the image to be detected, that is, the following steps S502-S503 are performed:

S502: Calculating a mean value and a variance of each pixel of the face area in gray space.

The mean value can be denoted with M and the variance can be denoted with Std.

It can be understood that, existing calculations for the mean value and the variance can be used for calculating of the mean value and the variance of each pixel of the face area in the gray space. Here, the embodiments of the present disclosure will not give too much explanation on how to calculate the mean value and the variance of each pixel of the face area in the gray space.

S503: Removing pixels corresponding to the preset factors from the face mask image according to the mean value and the variance of each pixel in the gray space, to obtain the smoothness analysis mask image corresponding to the image to be detected.

For example, the preset factors include at least one of five sense organs, reflection, and hair.

For example, when the pixels corresponding to the preset factors are removed from the face mask image according to the mean value and the variance of each pixel in the gray space to obtain the smoothness analysis mask image corresponding to the image to be detected, a pixel value of each pixel of the face mask image in the gray space can be calculated first. If the pixel value is greater than M+k*Std, it means that the pixel can be used to calculate the skin smoothness of the face subsequently and are the retained pixel; if the pixel value is less than or equal to M+k*Std, it means that the pixel is not used to calculate the skin smoothness of the face subsequently, and it needs to be removed, so as to remove the pixels corresponding to the preset factors from the face mask image, thereby obtaining the smoothness analysis mask image corresponding to the image to be detected. For example, the smoothness analysis mask image after removing the preset factors is shown in FIG. 4, where the smoothness analysis mask image shown in FIG. 4 only includes black pixels and white pixels, in which the black pixels are not used to calculate the skin smoothness of the face subsequently, and the white pixels are used to calculate the skin smoothness of the face subsequently.

It can be known that in the embodiment of the present disclosure, it is considered that the preset factors will affect the calculation of the skin smoothness of the face; therefore, in order to avoid the influence of the preset factors on the calculation of the skin smoothness of the face, the preset factors can be removed from the face mask image when the skin smoothness of the face is calculated to obtain the smoothness analysis mask image. In such a way, the smoothness analysis mask image after removing the preset factors is used to calculate the skin smoothness of the face subsequently, thereby avoiding the influence of the preset factors on the calculation of the skin smoothness of the face, and ensuring the accuracy of the skin smoothness of the face obtained through the calculation to a certain extent.

### Third Embodiment

FIG. 6 is a schematic structural diagram of an apparatus 60 for determining skin smoothness according to a third embodiment of the present disclosure. For example, please refer to FIG. 6, where the apparatus 60 for determining skin smoothness may include:

an obtaining module 601, configured to obtain an image to be detected, where the image to be detected includes a face area.

a processing module 602, configured to input the image to be detected and a smoothness analysis mask image corresponding to the image to be detected into a deep learning model to obtain a plurality of feature vectors for indicating the skin smoothness of the face; and determine, according to the plurality of feature vectors, the skin smoothness of the face in the image to be detected; wherein the smoothness analysis mask image does not includes preset factors including at least one of five sense organs, reflection and hair.

In an implementation, the processing module 602 is specifically configured to determine first K feature vectors with larger values from the plurality of feature vectors according to values of the plurality of feature vectors; and then determine the skin smoothness of the face in the image to be detected according to the first K feature vectors and the weight corresponding to each feature vector of the first K feature vectors; where said K is an integer greater than 0.

In an implementation, the deep learning model is obtained by training an initial deep neural network model with multiple groups of sample data; wherein each group of sample data include a sample image, a smoothness analysis mask image corresponding to the sample image and feature vectors for indicating the skin smoothness of the face in the sample image.

In an implementation, the processing module 602 is further configured to input the image to be detected into a detection model to obtain the face mask image corresponding to the image to be detected; and remove the preset factors from the face mask image to obtain the smoothness analysis mask image corresponding to the image to be detected.

In an implementation, the processing module 602 is specifically configured to calculate a mean value and a variance of each pixel of the face mask image in gray space; and remove pixels corresponding to the preset factors from the face mask image according to the mean value and the variance of each pixel in the gray space, so as to obtain the smoothness analysis mask image corresponding to the image to be detected.

In an implementation, the detection model is at least one of HSV color model, YCrCb color model, and RGB color model.

In an implementation, the obtaining module 601 is specifically configured to receive an inputted initial image to be detected, and perform pixel preprocessing on the initial image to be detected, so as to obtain the image to be detected.

The apparatus 60 for determining skin smoothness according to the embodiment of the present disclosure can perform the technical solution of the method for determining skin smoothness in any one of the above embodiments, the realization principle and beneficial effect of which are similar to those of the method for determining skin smoothness. Please refer to the realization principle and beneficial effect of the method for determining skin smoothness, and these will not be repeated here.

According to an embodiment of the present disclosure, the present disclosure further provides an electronic device and a readable storage medium.

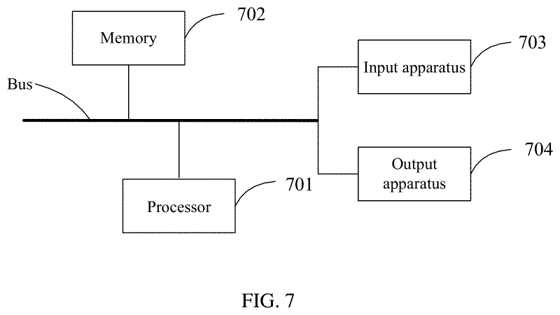

As shown in FIG. 7, FIG. 7 is a block diagram of an electronic device for performing the method for determining skin smoothness according to an embodiment of the present disclosure. The electronic device is intended to include various forms of digital computers, such as laptops, desktop computers, workstations, personal digital assistants, servers, blade servers, mainframe computers, and other suitable computers. The electronic device may also include various forms of mobile apparatuses, such as personal digital processing apparatuses, cellular phones, smart phones, wearable devices, and other similar computing apparatuses. Components shown herein, connections and relationships thereof, as well as functions thereof are merely exemplary and are not intended to limit implementations of the present disclosure described and/or required herein.

As shown in FIG. 7, the electronic device includes: one or more processors 701, a memory 702, and interfaces for connecting various components, including high-speed interfaces and low-speed interfaces. The various components are interconnected with different buses and can be installed on a common motherboard or be installed in other ways as required. The processor may process instructions executed in the electronic device, including instructions stored in or on a memory to display graphical information of GUI on an external input/output apparatus (for example, a display device coupled to an interface). In other embodiments, a plurality of processors and/or a plurality of buses may be used with a plurality of memories, if required. Also, a plurality of electronic devices can be connected, each of which provides some of necessary operations (for example, as a server array, a set of blade servers, or a multiprocessor system). In FIG. 7, one processor 701 is taken as an example.

The memory 702 is a non-transitory computer-readable storage medium according to the present disclosure. The memory stores instructions that can be executed by at least one processor to enable the at least one processor to perform the method for determining skin smoothness according to the present disclosure. The non-transitory computer-readable storage medium of the present disclosure stores computer instructions that enable the computer to perform the method for determining skin smoothness according to the present disclosure.

The memory 702, functioning as a type of non-transitory computer-readable storage medium, can be configured to store non-transitory software programs, non-transitory computer executable programs and modules, such as program instructions/modules corresponding to the method for determining skin smoothness in the embodiments of the present disclosure (e.g., the obtaining module 601 and the processing module 602 shown in FIG. 6). The processor 701 can execute various functional applications and data processing of a server by operating the non-transitory software programs, instructions and modules stored in the memory 702, that is, to realize the method for determining skin smoothness in the above method embodiments.

The memory 702 can include a program storing area and a data storing area, wherein the program storing area can store an operating system, one or more application program required for at least one function; the data storing area can store the data created by the electronic device performing the method for determining skin smoothness, and the like. In addition, the memory 702 may include high-speed random access memories, also may include non-transitory memories, such as at least one disk memory device, flash memory devices, or other non-transitory solid-state memory devices. In some embodiments, the memory 702 may include memories provided remotely relative to the processor 701, and the remotely provided memories may be connected via a network to the electronic device for performing the method for determining skin smoothness. Examples of the above network include but are not limited to the Internet, intranet, Local Area Network, mobile communication network and combinations thereof.

The electronic device for performing the method for determining skin smoothness may further include an input apparatus 703 and an output apparatus 704. The processor 701, the memory 702, the input apparatus 703 and the output apparatus 704 may be connected to one another via a bus or other means. A bus connection as an example is shown in FIG. 7.

The input apparatus 703 may receive inputted digital or character information, and generate key signal inputs related to user settings and functional control of the electronic device for performing the method for determining skin smoothness. Examples of the input apparatus include a touch screen, a keypad, a mouse, a trackpad, a touchpad, an indicating arm, one or more mouse buttons, a trackball, a joystick and the like. The output apparatus 704 may include a display device, an auxiliary lighting device (e.g., LED), a tactile feedback device (e.g., vibration motor), and the like. The display device may include, but is not limited to, a liquid crystal display (LCD), a light emitting diode (LED) display, and a plasma display. In some embodiments, the display device may be a touch screen.

The various embodiments of the systems and techniques described here may be implemented in digital electronic circuit systems, integrated circuit systems, special ASICs (special integrated circuits), computer hardware, firmware, software, and/or combinations thereof. These various embodiments may include: they may be implemented in one or more computer programs, where the one or more computer programs may be executed and/or interpreted on programmable systems including at least one programmable processor, where the programmable processor may be a special- or general-purpose programmable processor, which can receive data and instructions from a storage system, at least one input apparatus, and at least one output apparatus, and send the data and instructions to the storage system, the at least one input apparatus, and the at least one output apparatus.

These computing programs (also referred to as programs, software, software applications, or codes) include machine instructions of programmable processors, and can be implemented by using high-level processes and/or object-oriented programming languages, and/or assembly/machine languages. As used herein, the terms “machine-readable medium” and “computer-readable medium” refer to any computer program product, device, and/or apparatus (e.g., magnetic disk, optical disk, memory, programmable logic device (PLD)) for providing machine instructions and/or data to the programmable processor, including a machine-readable medium that receives machine instructions as machine-readable signals. The term “machine-readable signal” refers to any signal used to provide machine instructions and/or data to the programmable processor.

In order to provide interaction with a user, the systems and techniques described herein may be implemented on a computer, where the computer has: a display device (e. g., a CRT (cathode ray tube) or LCD (liquid crystal display) monitor) for displaying information to the user; and a keyboard and a pointing apparatus (e.g., a mouse or a trackball) through which the user can provide input to the computer. Other types of apparatuses may further be used to provide interaction with the user. For example, the feedback provided to the user may be any form of sensing feedback (e.g., visual feedback, auditory feedback, or tactile feedback); and input from the user may be received in any form (including acoustic input, voice input, or tactile input).

The systems and technologies described herein may be implemented in a computing system including a background component (for example, a data server), a computing system including a middleware component (for example, an application server), or a computing system including a front-end component (for example, a user computer having graphical user interfaces or web browsers, through which the user can interact with the embodiments of the systems and technologies described herein), or a computing system including any combination of the background component, middleware component, or front-end component. The components of the system may be interconnected through digital data communication (e. g., communication network) in any form or medium. Examples of the communication network include: local area network (LAN), wide area network (WAN), and Internet.

The computer system may include a client and a server. The client and the server are generally far away from each other and usually interact with each other through communication networks. The relationship between the client and the server is generated by computer programs running on corresponding computers and having the relationship between the client and the server.

According to the technical solutions of the embodiments of the present disclosure, when the skin smoothness is calculated, there is no need to detect the characteristics, such as stains, wrinkles, pores and the like, of the facial skin and weight the severity of the stains, wrinkles and pores of the facial skin to obtain the skin smoothness of the face, but employs such a solution that: after the image to be detected including a face area is obtained, the image to be detected and the smoothness analysis mask image corresponding to the image to be detected are inputted into the deep learning model to obtain a plurality of feature vectors for indicating the skin smoothness of the face. Because the smoothness analysis mask image does not include preset factors including at least one of five sense organs, reflection and hair, the influence of the preset factors on the skin smoothness is avoided, so that the accuracy for the skin smoothness of the face is ensured to a certain extent. Furthermore, the skin smoothness of the face in the image to be detected is obtained according to the plurality of feature vectors, thereby improving the efficiency for calculating the face skin while ensuring the accuracy.

It should be understood that the various forms of processes shown above can be used, and the steps can be reordered, added, or deleted. For example, the respective steps cited in the present disclosure can be performed in parallel, in sequence or in different orders, as long as results expected from the technical solutions disclosed by the present disclosure can be realized, and there is no limitation here.

The above specific embodiments do not constitute limitations on the protection scope of the present disclosure. It should be understood by those skilled in the art that various modifications, combinations, sub-combinations and replacements can be made according to design requirements and other factors. Any modification, equivalent replacement and improvement made within the spirit and principles of the present disclosure shall fall within the protection scope of the present disclosure.

What is claimed is:

1. A method for determining skin smoothness, comprising:
obtaining an image to be detected, the image to be detected comprising a face area;
inputting the image to be detected and a smoothness analysis mask image corresponding to the image to be detected into a deep learning model to obtain a plurality of feature vectors for indicating skin smoothness of a face; wherein the smoothness analysis mask image does not comprises preset factors and the preset factors comprise at least one of five sense organs, reflection and hair; and
determining, according to the plurality of feature vectors, the skin smoothness of the face in the image to be detected.

2. The method according to claim 1, wherein the determining, according to the plurality of feature vectors, the skin smoothness of the face in the image to be detected, comprises:
determining first K feature vectors with larger values from the plurality of feature vectors according to values of the plurality of feature vectors; where said K is an integer greater than 0; and
determining the skin smoothness of the face in the image to be detected, according to the first K feature vectors and weight corresponding to each feature vector of the first K feature vectors.

3. The method according to claim 1, wherein:
the deep learning model is obtained by training an initial deep neural network model with multiple groups of sample data; where each group of the sample data comprises a sample image, a smoothness analysis mask image corresponding to the sample image and the feature vectors for indicating skin smoothness of a face in the sample image.

4. The method according to claim 1, wherein before the inputting the image to be detected and a smoothness analysis mask image corresponding to the image to be detected into a deep learning model to obtain a plurality of feature vectors for indicating skin smoothness of a face, the method further comprises:
inputting the image to be detected into a detection model to obtain a face mask image corresponding to the image to be detected; and
removing the preset factors from the face mask image to obtain the smoothness analysis mask image corresponding to the image to be detected.

5. The method according to claim 4, wherein the removing the preset factors from the face mask image to obtain the smoothness analysis mask image corresponding to the image to be detected, comprises:
calculating a mean value and a variance of each pixel of the face mask image in gray space; and
removing pixels corresponding to the preset factors from the face mask image according to the mean value and the variance of each pixel in the gray space, to obtain the smoothness analysis mask image corresponding to the image to be detected.

6. The method according to claim 4, wherein,
the detection model is at least one of HSV color model, YCrCB color model, and RGB color model.

7. The method according to claim 1, wherein the obtaining an image to be detected, comprises:
receiving an inputted initial image to be detected, and
pixel preprocessing on the initial image to be detected to obtain the image to be detected.

8. An electronic device, comprising:
at least one processor; and
a memory, connected with the at least one processor in communication;
wherein the memory stores instructions executable by the at least one processor, and the instructions are executed by the at least one processor to cause the at least one processor to:
obtain an image to be detected, the image to be detected comprising a face area;
input the image to be detected and a smoothness analysis mask image corresponding to the image to be detected into a deep learning model to obtain a plurality of feature vectors for indicating skin smoothness of a face; wherein the smoothness analysis mask image does not comprises preset factors and the preset factors comprise at least one of five sense organs, reflection and hair; and
determine, according to the plurality of feature vectors, the skin smoothness of the face in the image to be detected.

9. The electronic device according to claim 8, wherein the instructions are executed by the at least one processor to further cause the at least one processor to:
determine first K feature vectors with larger values from the plurality of feature vectors according to values of the plurality of feature vectors; where said K is an integer greater than 0; and
determine the skin smoothness of the face in the image to be detected, according to the first K feature vectors and weight corresponding to each feature vector of the first K feature vectors.

10. The electronic device according to claim 8, wherein the instructions are executed by the at least one processor to further cause the at least one processor to:
obtain the deep learning model by training an initial deep neural network model with multiple groups of sample data; where each group of the sample data comprises a sample image, a smoothness analysis mask image corresponding to the sample image and the feature vectors for indicating skin smoothness of a face in the sample image.

11. The electronic device according to claim 8, wherein the instructions are executed by the at least one processor to further cause the at least one processor to:
input the image to be detected into a detection model to obtain a face mask image corresponding to the image to be detected; and
remove the preset factors from the face mask image to obtain the smoothness analysis mask image corresponding to the image to be detected.

12. The electronic device according to claim 11, wherein the instructions are executed by the at least one processor to further cause the at least one processor further to:
calculate a mean value and a variance of each pixel of the face mask image in gray space; and
remove pixels corresponding to the preset factors from the face mask image according to the mean value and the variance of each pixel in the gray space, to obtain the smoothness analysis mask image corresponding to the image to be detected.

13. The electronic device according to claim 11, wherein,
the detection model is at least one of HSV color model, YCrCB color model, and RGB color model.

14. The electronic device according to claim 8, wherein the instructions are executed by the at least one processor to further cause the at least one processor further to:
receive an inputted initial image to be detected, and
pixel preprocess on the initial image to be detected to obtain the image to be detected.

15. A non-transitory computer-readable storage medium storing computer instructions, wherein the computer instructions are configured to cause a computer to:
obtain an image to be detected, the image to be detected comprising a face area;
input the image to be detected and a smoothness analysis mask image corresponding to the image to be detected into a deep learning model to obtain a plurality of feature vectors for indicating skin smoothness of a face; wherein the smoothness analysis mask image does not comprises preset factors and the preset factors comprise at least one of five sense organs, reflection and hair; and
determine, according to the plurality of feature vectors, the skin smoothness of the face in the image to be detected.

16. The non-transitory computer-readable storage medium according to claim 15, wherein the computer instructions are further configured to cause a computer to:
determine first K feature vectors with larger values from the plurality of feature vectors according to values of the plurality of feature vectors; where said K is an integer greater than 0; and
determine the skin smoothness of the face in the image to be detected, according to the first K feature vectors and weight corresponding to each feature vector of the first K feature vectors.

17. The non-transitory computer-readable storage medium according to claim 15, wherein the computer instructions are further configured to cause a computer to:
obtain the deep learning model by training an initial deep neural network model with multiple groups of sample data; where each group of the sample data comprises a sample image, a smoothness analysis mask image corresponding to the sample image and the feature vectors for indicating skin smoothness of a face in the sample image.

18. The non-transitory computer-readable storage medium according to claim 15, wherein the computer instructions are further configured to cause a computer to:
input the image to be detected into a detection model to obtain a face mask image corresponding to the image to be detected; and
remove the preset factors from the face mask image to obtain the smoothness analysis mask image corresponding to the image to be detected.

19. The non-transitory computer-readable storage medium according to claim 18, wherein the computer instructions are further configured to cause a computer to:
calculate a mean value and a variance of each pixel of the face mask image in gray space; and
remove pixels corresponding to the preset factors from the face mask image according to the mean value and the variance of each pixel in the gray space, to obtain the smoothness analysis mask image corresponding to the image to be detected.

20. The non-transitory computer-readable storage medium according to claim 15, wherein the computer instructions are further configured to cause a computer to:
receive an inputted initial image to be detected, and
pixel preprocess on the initial image to be detected to obtain the image to be detected.
